(19) United States
(12) Patent Application Publication
(10) Pub. No.: US 2023/0351914 A1
(43) Pub. Date: Nov. 2, 2023

(54) VIRTUAL REALITY SIMULATIONS FOR TRAINING

(71) Applicant: Dell Products L.P., Round Rock, TX (US)

(72) Inventors: Osnat Sasha, Holon (IL); Alex Kulakovsky, Jerusalem (IL); Omer Margolin, Tel-Aviv (IL)

(73) Assignee: Dell Products L.P., Round Rock, TX (US)

(21) Appl. No.: 17/732,184

(22) Filed: Apr. 28, 2022

(51) Int. Cl. G09B 19/00; G09B 5/02

(52) U.S. Cl. CPC G09B 19/003; G09B 5/02

(57) ABSTRACT

Techniques described herein provide virtual reality simulations for training. A user may select a training program for a product. A virtual environment associated with the training program may be loaded, and a task of the training program retrieved. An event based on user input to the virtual environment may be identified, and compared to an event required to complete the task. Whether a user completed the task may be determined.

### BACKGROUND

### Technical Field

This application relates to virtual reality simulations for training users or service personnel on products.

### Description of Related Art

Conventionally, users maintain or repair products by following instructions provided in written guides, videos, or training with physical products in the physical world. Because such formats may be onerous to follow, a user may be unable to maintain or repair the product, or may accomplish the tasks with significant difficulty. As a result, the user may become unsatisfied with the product.

### SUMMARY OF THE INVENTION

One aspect of the current technique is a method for providing virtual reality simulations for training. The method includes receiving a user selection of a training program for a product. The method includes loading a virtual environment associated with the training program. The method includes retrieving a task of the training program. The method includes identifying an event based on user input to the virtual environment. The method includes comparing the event to an event required to complete the task. The method includes determining whether a user completed the task.

In some embodiments, a score may be determined for the user based on the comparison of the event to the event required to complete the task. The score for the user may be displayed in a user interface to provide feedback regarding a performance of the user. The virtual environment is created based on a data model associated with the product. The event may be identified based on signals received from virtual reality gloves or other user tracking devices. When the user partially completes the task, an informational message may be displayed, along with an instruction on how the user attempt partially completed the task. When the user fails to complete the task, the virtual environment may be reset for the user to re-attempt the task. When the user fails to complete the task, an error message may be displayed, along with an instruction on how the user attempt failed to complete the task. When the user completes the task, a subsequent task from the training program may be retrieved.

Another aspect of the current technique is a system, with a processor, for providing virtual reality simulations for training. The processor may be configured to perform any process in conformance with the aspect of the current techniques described above.

Another aspect of the current technique is a non-transitory computer-readable storage medium with program code stored therein. When executed, the program code may perform any process in conformance with the aspect of the current techniques described above.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 depicts an exemplary information handling system that may be used in connection with performing the techniques described herein;

FIG. 2 depicts exemplary input devices and displays for use with the information handling system of FIG. 1;

FIG. 3 depicts an exemplary computing device for use in the information handling system of FIG. 1;

FIGS. 4-5 depict exemplary user interfaces that may be displayed to a user for selecting a training program associated with a product;

FIG. 6 depicts exemplary modules launched by a training program associated with a product;

FIGS. 7-16 depict exemplary screenshots from within a virtual environment run by a training program; and

FIG. 17 is an exemplary flow diagram of a method of providing virtual reality simulations for training.

### DETAILED DESCRIPTION OF EMBODIMENT(S)

Described below are techniques for providing virtual reality simulations for training. A user may select a training program for a given product. A virtual environment associated with the training program may be loaded, and a task of the training program retrieved. An event based on user input to the virtual environment may be identified, and compared to an event required to complete the task. Whether a user completed the task may be determined.

Some aspects of product installation, repair, and maintenance can be undertaken by a user, such as part replacement and cable rewiring. However, training users to perform these tasks poses some challenges. Conventional approaches, such as written instructions and videos, may not provide adequate detail and cannot correct a user who is making errors. Moreover, conventional training on products in the physical world may not provide adequate access to resources, such as to service personnel or to the product. For example, these formats do not provide access to service personnel with the right knowledge to assist, as service personnel may be off-site or remote. Furthermore, if the product involves extensive physical equipment, and/or it is in locations with limited access (e.g., laboratories), the users’ lack of familiarity with the product will decrease the likelihood that training via conventional methods will yield successful outcomes.

Trainings using virtual reality can overcome the obstacles posed by the conventional methods. Simulations remove the requirement to physically access a product to gain hands-on understanding of its workings. Further, simulations remove the requirement that the user have physical access to the product, which may in limited supply or otherwise not easily available. Additionally, by simulating the environment in which the user would install, repair, or maintain a product, the user can practice performing the tasks before they are required. Gaining familiarity with products and the steps needed to address their issues increases the user’s confidence in their ability to remedy problems when they arise. In fact, even when a problem surfaces, through the virtual simulations, the user can practice remedying the issue before attempting to work on the product itself. Thus, an information handling system that uses virtual reality to train a user to address issues for a product can increase the likelihood of the user successfully installing, repairing, and maintaining the product, and thus improve the user’s satisfaction with the product. Additionally, the present information handling system can reduce the duration of the user’s service visits to customer sites for repairing physical products, thereby reducing costs for the customer and for the user’s employer.

The techniques described herein provide virtual reality simulations for trainings. In at least some implementations in accordance with the techniques as described herein, one or more of the following advantages can be provided: stronger command of techniques for installing, repairing, and maintaining products; ease of accessibility to training; improved tailoring of training to user; and greater user satisfaction with the product.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, utilize, or analyze any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

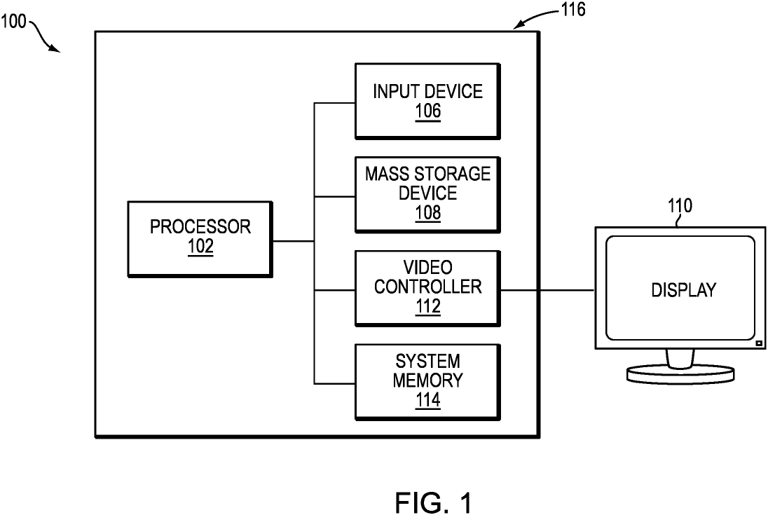

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

The mass storage device 108 can store programs for training users or support personnel. Each program may correspond to a unique product, with modules dedicated to different facets of the product. Each program, when executed, provides a virtual reality environment in which the user may be trained with respect to a particular product. For example, one module can provide a simulation guiding the user through installation of the product. Other modules may be dedicated to common errors of the product. Such modules can provide simulations training the user to repair the product when the applicable error arises. Additional modules may be concerned with maintaining the product. For example, a module may simulate a training on running diagnostics for the product, the results of which may be used to adjust the product so as to optimize its performance. The IHS 100 may display on display 110 a user interface with a menu of the programs on the mass storage device 108, and the user may select a program to run.

Moreover, each program may include a data model that includes information about the input devices required to run the program, the tasks the user must perform to complete the training, instructions and follow-up guidance to users for performing the tasks, and criteria for assessing the sufficiency of user attempts to perform tasks. The data model also includes data for rendering user interfaces related to any of these features for display to the user.

In some embodiments, the IHS 100 is configured to communicate over a computer network with other IHSs 100′ (not shown). The other IHSs 100′ may store updates to training programs. In some embodiments, the other IHSs′ 100 transmit the updates to the IHS 100 whenever the updates become available. In other embodiments, the IHS 100 polls the other IHSs 100′ on a periodic basis for updates, and the IHSs 100′ transfers the program updates available when polled.

The updates may alter the programs to include new tasks or to update existing tasks. For example, when a new version of a product is released, the corresponding training program(s) may be updated to correspond to the current features of the product. In another example, should additional common errors or new best practices for maintenance emerge as the product matures, the training program may be updated to enable a user to repair or maintain the product according to the developments.

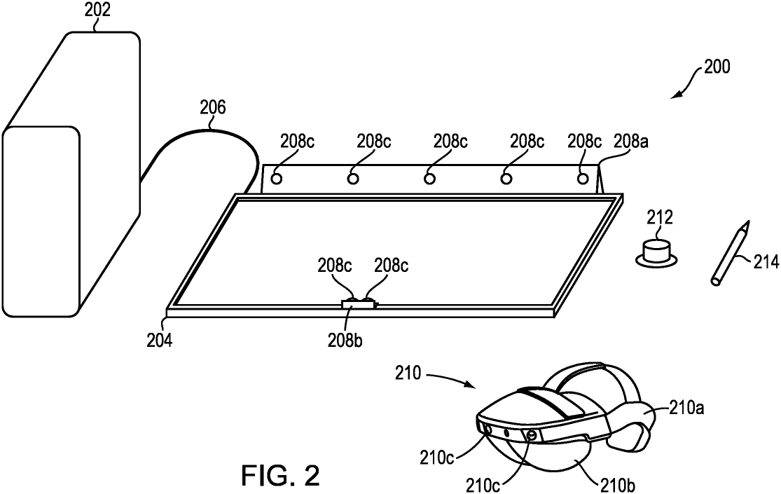

Referring now to FIG. 2, an embodiment of a virtual reality workspace system 200 is illustrated. In the illustrated embodiment, the virtual reality workspace system 200 includes a computing device 202 that may be the IHS 100 discussed above with reference to FIG. 1, and/or that may include some of all of the components of the IHS 100. One of skill in the art in possession of the present disclosure will recognize that while the computing device 202 is illustrated as a desktop computing device, other types of computing devices (e.g., laptop/notebook computing devices and/or other mobile computing devices, computing devices integrated into other components of the virtual reality workspace system 200, and/or other types of computing devices) will fall within the scope of the present disclosure as well. As discussed in further detail below, the computing device 202 may be coupled to other components of the virtual reality workspace system 200 via wired and/or wireless couplings. Furthermore, while a separate computing device 202 is illustrated in FIG. 2, the functionality of the computing device 202 may instead by provided by a computing system that may be at least partially distributed across the components of the virtual reality workspace system 200.

For example, the virtual reality workspace system 200 of the illustrated embodiment includes a physical display device 204 that is connected to the computing device 202 by a wired connection 206, although wireless connections between the computing device 202 and the physical display device 204 (or integration of at least some of the computing device functionality discussed below in the physical display device 204) will fall within the scope of the present disclosure as well. In an embodiment, the physical display device 204 may include the display 110 discussed above with reference to FIG. 1. The physical display device 204 includes a display screen 204a that, in the embodiments illustrated and discussed below, is provided in a substantially horizontal orientation relative to a user of the virtual reality workspace system 200, as well as substantially parallel to the support surface upon which it is located (e.g., a working surface of a desk.) For example, one of skill in the art in possession of the present disclosure will recognize that display screens have been traditionally provided in substantially vertical orientations relative to users, as well as substantially perpendicularly to their support surfaces (e.g., the working surface of the desk discussed above), and that the display screen 204a of the physical display device 204 is described below as provided in a substantially horizontal orientation that is rotated substantially ninety degrees from those substantially vertical orientations. For example, the physical display device 204 may be provided as part of a “smart desk” that provides a horizontally oriented, touch-input display device (which may be utilized by itself or in conjunction with a vertically oriented display device), although other horizontally oriented display screens will fall within the scope of the present disclosure as well. Furthermore, the provisioning of the physical display device 204 and its display screen 204a in other orientations (e.g., the vertical orientation discussed above) will fall within the scope of the present disclosure as well.

In the illustrated embodiment, a user tracking subsystem 208a and 208b is integrated with the physical display device 204, although a user tracking subsystem that is separate from the physical display device 204 (and separately coupled to the computing device 202 via a wired or wireless connection) will fall within the scope of the present disclosure as well. As such, in some embodiments the user tracking subsystem 208a and 208b may include at least some of the computing device functionality described below for the physical display device 204. The user tracking subsystem 208a and 208b may include a plurality of user tracking devices 208c that may be provided by infrared (IR) sensors, IR sensor arrays (e.g., “IR castors”), three-dimensional cameras (e.g., if the processing system in the computing system has sufficient processing capabilities), and/or a variety of other user tracking devices that would be apparent to one of skill in the art in possession of the present disclosure. While the virtual reality workspace system 200 is illustrated with the user tracking subsystem 208a positioned at the “top” of the physical display device 204 and the user tracking subsystem 208b positioned at the “bottom” of the physical display device 204, user tracking subsystems with different numbers of components in different configurations and/or orientations will fall within the scope of the present disclosure as well.

In the illustrated embodiment, a virtual reality display subsystem 210 is included with the virtual reality workspace system 200, and provides a head-mounted user tracking and display subsystem. For example, the virtual reality display subsystem 210 includes a chassis 210a that is configured to be worn on a user’s head such that a display device 210b is positioned in front of the user’s eyes. In the discussions below, the display device 210b is provided by a transparent Organic Light Emitting Device (OLED) display device, although other display devices that provide the functionality discussed below may fall within the scope of the present disclosure as well. The virtual reality display subsystem 210 may also include a plurality of cameras 210c that are configured to capture images in the field of view of a user wearing the virtual reality display subsystem 210. In the examples discussed below, the virtual reality display subsystem 210 is wirelessly coupled to the computing device 202, although wired connections will fall within the scope of the present disclosure as well. While in the embodiments discussed below, much of the computing device processing for the display of images by the virtual reality display subsystem 210 is performed by the computing device 202 in order to provide a relatively small and lightweight virtual reality display subsystem 210, in other embodiments the virtual reality display subsystem 210 may perform at least some of the computing device functionality discussed below. While not explicitly illustrated, the virtual reality display subsystem 210 may include a variety of other components for use in the user tracking functionality discussed below, including IR markers (e.g., for use by IR sensors or IR sensor arrays in the user tracking subsystem 208a and 208b), accelerometers, gyroscopes, locations sensors, and/or a variety of other tracking components that would be apparent to one of skill in the art in possession of the present disclosure. In experimental embodiments, the virtual reality display subsystem 210 was provided by a META 2® headset provided by META® company of California, United States, although other virtual reality display subsystems will fall within the scope of the present disclosure as well. However, while a specific virtual reality display subsystem has been described, one of skill in the art in possession of the present disclosure will recognize that light field display devices, projection display devices, and/or other virtual reality display subsystems may be substituted for the virtual reality display subsystem 210 while remaining within the scope of the present disclosure.

In the illustrated embodiment, the virtual reality workspace system 200 also includes a totem device 212 and a pen device 214, each of which may be wirelessly connected to the computing device 202 (although wired connections will fall within the scope of the present disclosure as well), or capable of being tracked by the virtual reality display subsystem 210 and/or the user tracking subsystem 208a and 208b. Furthermore, each of the totem device 212 and the pen device 214 may include tracking components such as IR markers (e.g., for use by IR sensors or IR sensor arrays in the user tracking subsystem 208a and 208b), cameras, accelerometers, gyroscopes, locations sensors, and/or a variety of other tracking components that would be apparent to one of skill in the art in possession of the present disclosure. While a specific virtual reality workspace system has been described, one of skill in the art in possession of the present disclosure will recognize that virtual reality workspace systems may include a variety of components in a variety of different configurations in order to provide for conventional virtual reality workspace functionality, as well as the functionality discussed below, while remaining within the scope of the present disclosure.

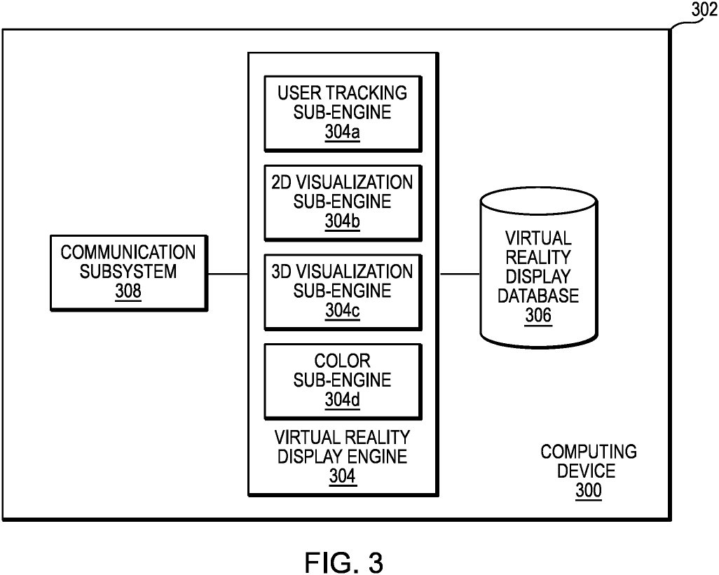

Referring now to FIG. 3, an embodiment of a computing device 300 is illustrated that may be the computing device 202 discussed above with reference to FIG. 2. As such, the computing device 300 may be the IHS 100 discussed above with reference to FIG. 1, and/or may include some or all of the components of the IHS 100, and in specific embodiments may be a desktop computing device (although other types of computing devices will fall within the scope of the present disclosure as well, as discussed above.) Furthermore, as discussed above, while a separate computing device 300 is illustrated in FIG. 300, the functionality of the computing device 300 may instead by provided by a computing system that may be at least partially distributed across the components of the virtual reality workspace system 200. In the illustrated embodiment, the computing device 300 includes a chassis 302 that houses the components of the computing device 300, only some of which are illustrated in FIG. 3. For example, the chassis 302 may house a processing system (not illustrated, but which may include the processor 102 discussed above with reference to FIG. 1) and a memory system (not illustrated, but which may include the system memory 114 discussed above with reference to FIG. 1) that is coupled to the processing system and that includes instructions that, when executed by the processing system, cause the processing system to provide a virtual reality display engine 304 that is configured to perform the functions of the virtual reality display engines and computing devices discussed below. However, as discussed above, rather than being provided in a separate computing device, the functionality and/or processing performed by the computing device as discussed below may instead be integrated into components of the virtual reality workspace system 200 (e.g., the physical display device 204, the user tracking subsystem 208a and 208b, the virtual reality display subsystem 210, etc.) while remaining within the scope of the present disclosure.

In the illustrated embodiment, the virtual reality display engine 304 includes a user tracking sub-engine 304a that may be configured to utilize user tracking information to determine the position of the user (e.g., the user’s head, the user’s hands, and/or other portions of the user), a two-dimensional visualization sub-engine 304b that may be configured to generate the two-dimensional elements on the display screen 204a of the physical display device 204, a three-dimensional visualization sub-engine 304c that may be configured to generate the virtual reality elements via the virtual reality display subsystem 210, and a color sub-engine 304d that may be configured to determine color details of the two-dimensional and virtual reality elements generates by the two-dimensional visualization sub-engine 304b and the three-dimensional visualization sub-engine 304c. However, while an example of specific sub-engines and components of the virtual reality display engine 304 have been illustrated and are described in more detail below, one of skill in the art in possession of the present disclosure will recognize that the virtual reality display engine 304 may include more or fewer sub-engines, and those sub-engines may be distributed across multiple different components of the virtual reality workspace system 200 (e.g., the user tracking sub-engine 304a provided in the user tracking subsystem 208a and 208b, two-dimensional visualization sub-engine 304b provided in the physical display device 204, the three-dimensional visualization sub-engine 304c provided in the virtual reality display subsystem 210, etc.) while remaining within the scope of the present disclosure.

The chassis 302 may also house a storage system (not illustrated, but which may include the storage device 108 discussed above with reference to FIG. 1) that is coupled to the virtual reality display subsystem 304 (e.g., via a coupling between the storage system and the processing system) and that may include a virtual reality display database 306 that is configured to store any of the information that is used to provide the functionality discussed below. The chassis 302 may also house a communication subsystem 308 that is coupled to the virtual reality display subsystem 304 (e.g., via a coupling between the communication subsystem 308 and the processing system) and that may include a Network Interface Controller (NIC) (e.g., for providing the wired connections discussed above), a wireless communication device (e.g., a BLUETOOTH® communications device, a Near Field Communications (NFC) device, a WiFi communications devices, and/or other wireless communications devices for providing the wireless connections discussed above), and/or other communications components that would be apparent to one of skill in the art in possession of the present disclosure. While a specific computing device has been illustrated and described, one of skill in the art in possession of the present disclosure will recognize that computing devices may include a variety of components in a variety of configurations in order to provide conventional computing device functionality, as well as the functionality discussed below, while remaining within the scope of the present disclosure.

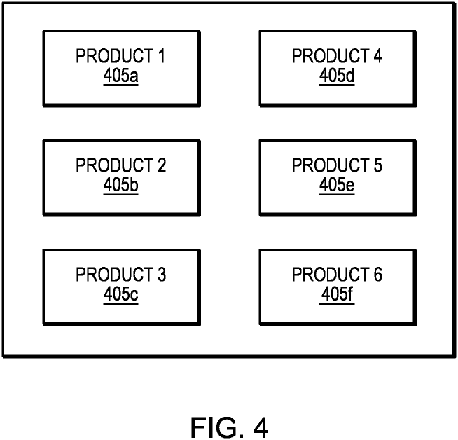

FIG. 4 depicts an exemplary user interface 400 that may be displayed on a physical display device 204 or virtual reality display subsystem 210. The user interface 400 may be a menu identifying the products 405a-430f (individually and collectively, “405”) for which training programs are available. Although the interface 400 depicts six (6) products, any number of products may be presented, according to the number of programs stored on the HIS 100. The user may select a product 405 using any of the input devices described with respect to FIGS. 1 and 2.

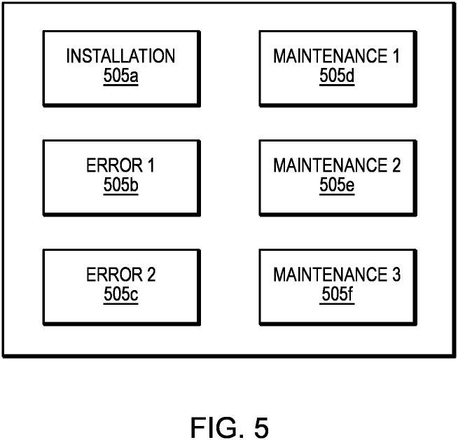

FIG. 5 depicts an exemplary user interface 500 that may be displayed after a user selects a product 405 from the user interface 400 of FIG. 4. The user interface 500 displays the training programs 505a-505f (individually and collectively, “505”) for the selected product. The training programs 505 may guide the user through installation, repair, and/or maintenance of the product. For example, program 505a trains the user on installing the product. Programs 505b and 505c train the user to repair the product when particular errors arise. Programs 505d-505f guide the user through different procedures advisable for maintaining the product.

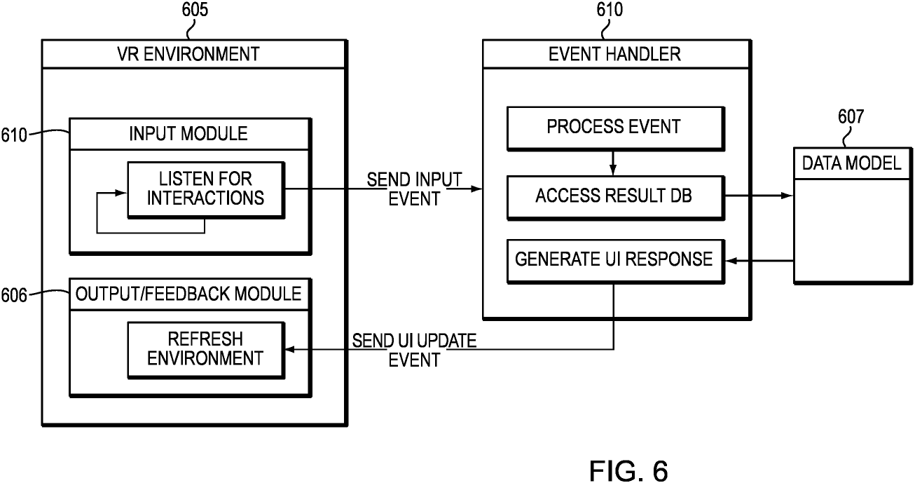

FIG. 6 depicts exemplary modules that are run by any of the programs 505 stored on the mass storage device 108 of FIG. 1. When the processor 102 runs one of the programs 505, the processor 102 launches a virtual environment 605 to provide training for a particular product. The virtual environment 605 includes an output module 606 coupled to the physical display device 204 and/or the virtual reality display subsystem 210. After retrieving data specific to the product from the data model 607, the processor 102 uses at least the 2D and/or the 3D visualization sub-engines 304b, 304c of the virtual reality display engine 304 to simulate an environment 605 in which the user can interact with the product, which the output module 606 sends to the physical display device 204 and/or the virtual reality display subsystem 210.

The virtual environment 605 includes an input module 410. The input module 410 is coupled to various input devices 106 described with respect to FIGS. 1 and 2. For example, the input module 410 may be coupled to user tracking devices 208c such as infrared (IR) sensors, IR sensor arrays (e.g., “IR castors”), or three-dimensional cameras. Additional input devices 106 may include a totem device 212 that the user may hold, virtual reality gloves (not shown) for the user to wear, and/or a pen device 214 the user may deploy to select items on a touchscreen display. The input module 410 monitors signals from these devices 106, and when the signals can be interpreted as intentional movements and/or selections by the user, the inputs are provided to the event handler 610 of the program 505.

To train the user, the program 505 outputs instructions to guide the user in performing tasks. After each instruction is displayed, the event handler 610 waits for the user to complete the requested action. The input module 610 interprets signals from input devices 106, and when the signals amount to an input event, the input event is sent to the event handler 610 to process. The event handler 610 uses data from the data model 607 to determine if the input event satisfies the instruction presented to the user.

Based on the data model 607 and the input event, the event handler 610 generates a response to the user. The response is sent to the output module 606 of the virtual environment 605, to update the display on the physical display device 204 and/or the virtual reality display subsystem 210. For example, if the input event is unsatisfactory, the virtual environment 605 may reset to the display originally accompanying the instruction. The user may be invited to reattempt the task. In some embodiments, the virtual environment 605 may display an explanation why the user’s input was incorrect and/or inadequate, and provide more detailed guidance on how to complete the task. In another example, if the input event is satisfactory, the event handler 610 deems the user to have been properly trained for the task, and the program 505 advances to the next task in the training. Consequently, the event handler 610 updates the virtual environment 605 to display a new instruction to the user and to present the product in the state requiring a next task to be performed. The processor 102 iterates through the tasks in the program 505 until the user completes all of them.

Using the modules described with respect to FIG. 6, a training program 505 may provide feedback to a user in real-time. For example, if the event handler 610 determines that an event by the user does not sufficiently perform a task, the event handler 610 can cause the output module 606 to display an error message. In some embodiments, the event handler 610 resets the virtual environment 605 for the user to re-perform the task, and retrieves from the data model 607 instructions in which the task is divided into subtasks, and the output module 606 displays instructions for each subtask. In this manner, the training program 505 may provide more detailed guidance to the user after the need for such is identified. The output module 610 can also display information about common mistakes in making a repair or performing the maintenance task.

In some embodiments, the training program 505 may score the performance of a user. For example, the number of tasks the user performed successfully may be tallied and compared against the total number of tasks, and the results presented to the user. The training program 505 may display the score so as to provide general feedback regarding the performance of the user. For example, the score may be displayed in real time in the training program 505, such as in a simulated user interface. Alternatively, the score may be displayed in a user interface separate from the training program 505 enabling the user to receive general feedback on the user’s historical performance. The user may be presented with the option to repeat the tasks that were not initially performed successfully. In some embodiments, the training program 505 ends only after the user has successfully completed each task. Moreover, the training program may prepare a certificate stating that the user has completed the training for the product, for the applicable installation, repair, or maintenance tasks.

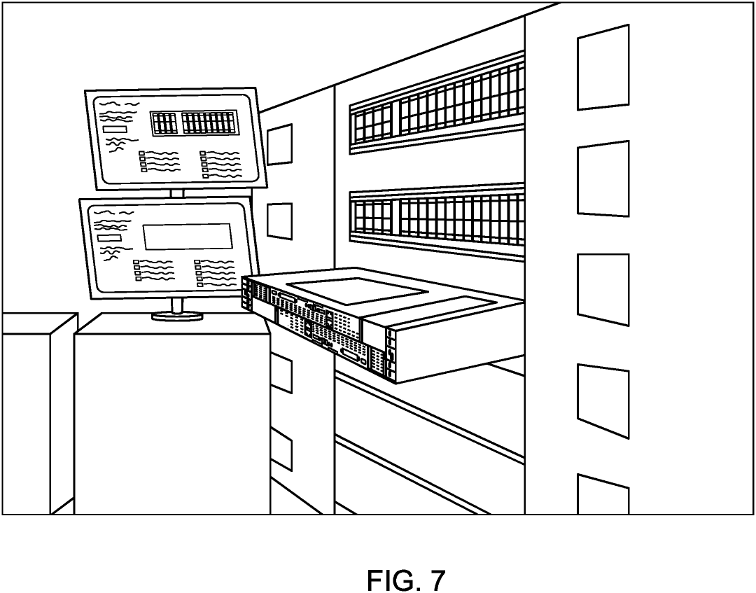

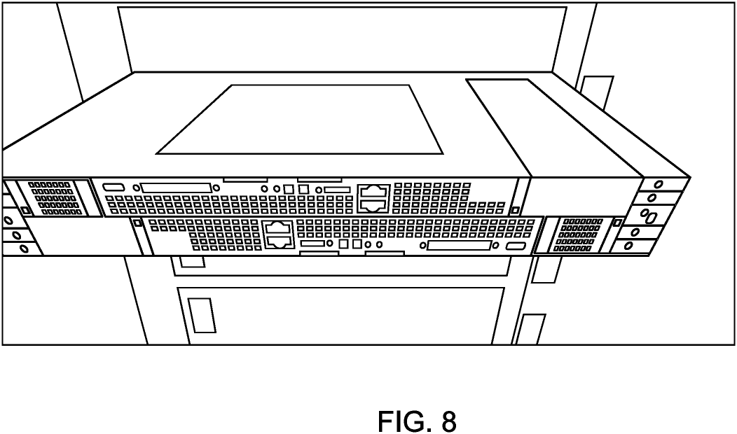

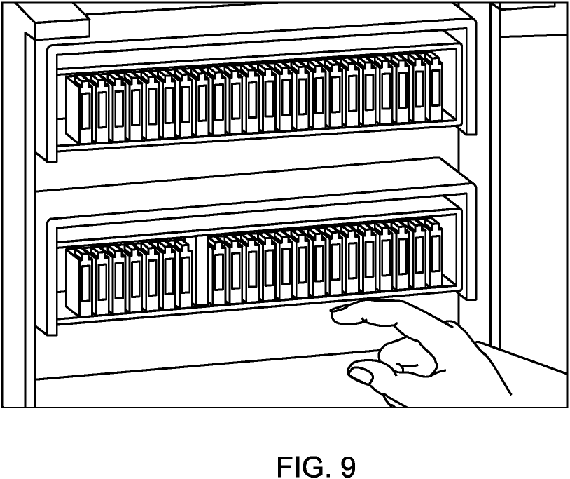

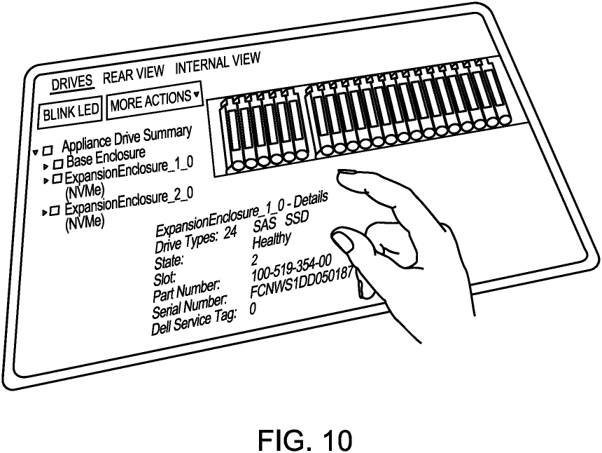

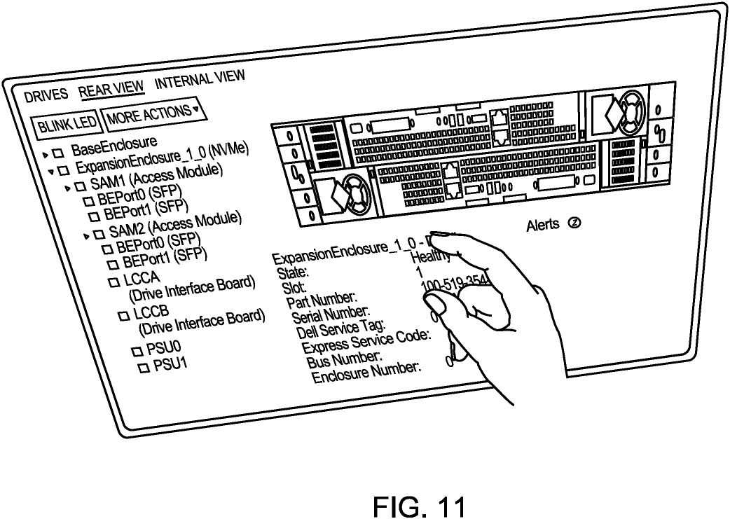

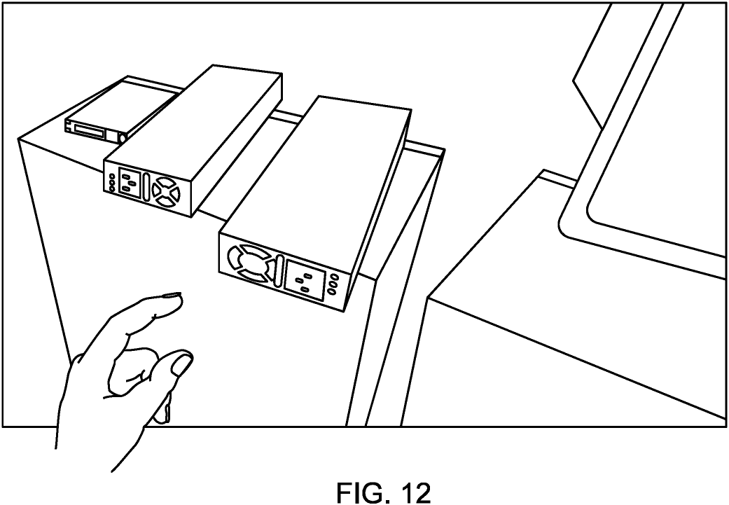

FIGS. 7-16 depict exemplary screenshots of a virtual environment 605 providing a simulation to train a user on a product. FIG. 7 depicts a virtual server room. Three expansion shelves for a product can be seen, as well as two screens with user interfaces depicting the system status. FIG. 8 depicts the bottom expansion shelf in an extended, back-facing view. Spaces a color-coded to indicate that a part is missing. FIG. 9 show the two top expansion shelves, which are forward facing so that the drives are visible. A color-coded space indicates where a drive is missing. FIG. 10 depicts one of the user interfaces displayed on a screen in the virtual environment 605, alerting the user that an expansion shelf is missing a drive in a particular slot. FIG. 11 depicts the other of the user interfaces, highlighting that two power supplies are missing from the bottom expansion shelf. FIG. 12 depicts an SSD drive and two power supplies lying on a platform next to the screens in the virtual environment 605.

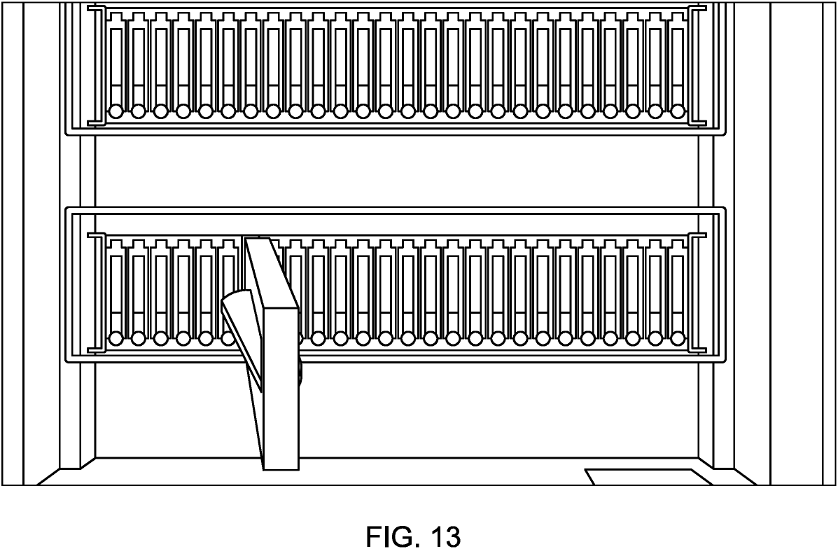

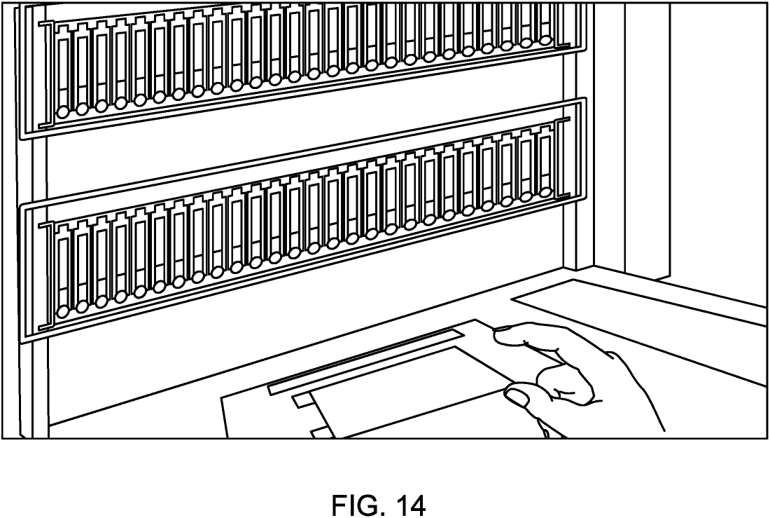

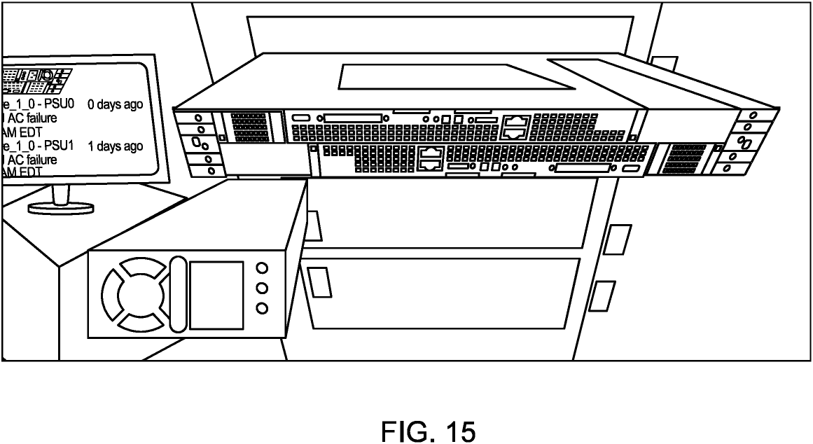

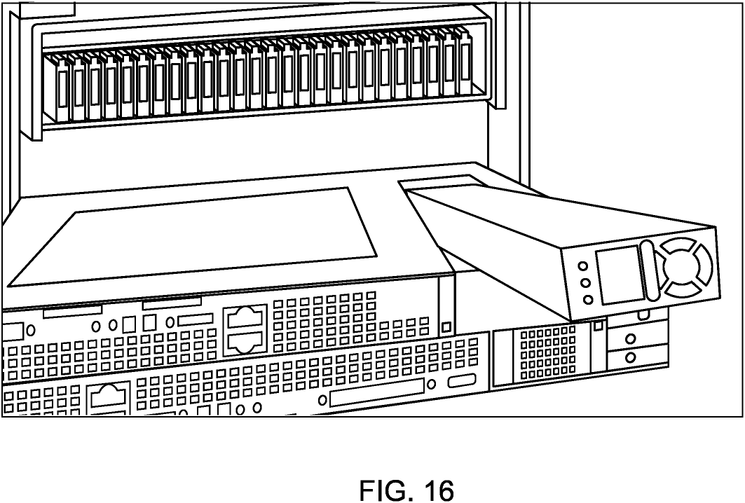

The user may pick up the SSD drive in the virtual environment 605, and insert the SSD drive into the empty slot in the middle expansion shelf, as shown in FIG. 13. When the SSD drive is correctly positioned, the drive snaps into place in the display, as shown in FIG. 14. Similarly, the user may pick up the power supplies and insert them into the bottom expansion shelf, as shown in FIGS. 15 and 16. If the power supplies are positioned correctly, the power supplies snap into place.

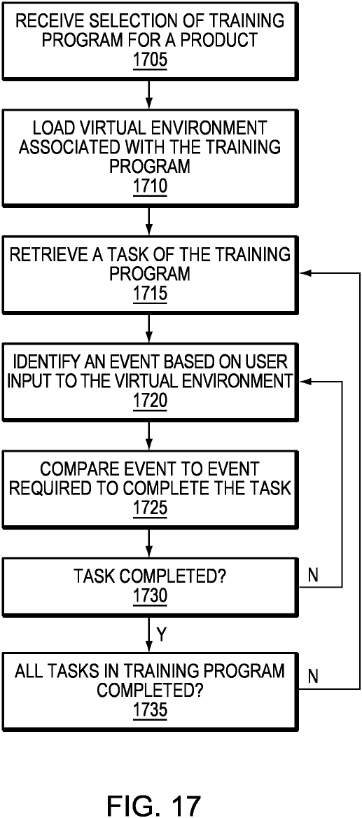

FIG. 17 is an exemplary flow diagram of a method for providing virtual reality simulations for training. A selection of a training program for a product is received (step 1705), and a virtual environment associated with the training program is loaded (step 1710). A task of the training program is retrieved (step 1715). The method identifies an event based on user input to the virtual environment (step 1720), and this event is compared to the event required to complete the task (step 1725). The method determines whether the task has been completed (step 1730). In some embodiments, the method determines whether the task has been fully or partially completed. If the task has not been fully completed, then subsequent events based on user inputs to the virtual environment are identified and compared to events required to complete the task. Otherwise, the method determines whether all tasks in the training program have been completed (step 1735). If tasks remain, then the next task in the training program is retrieved (step 1715). If all the tasks have been completed, the training program has been completed.

It should again be emphasized that the implementations described above are provided by way of illustration, and should not be construed as limiting the present invention to any specific embodiment or group of embodiments. For example, the invention can be implemented in other types of systems, using different arrangements of processing devices and processing operations. Also, message formats and communication protocols utilized may be varied in alternative embodiments. Moreover, various simplifying assumptions made above in the course of describing the illustrative embodiments should also be viewed as exemplary rather than as requirements or limitations of the invention. Numerous alternative embodiments within the scope of the appended claims will be readily apparent to those skilled in the art.

Furthermore, as will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method for providing virtual reality simulations for training, the method comprising:
receiving a user selection of a training program for a product;
loading a virtual reality environment associated with the training program;
retrieving a task of the training program;
processing user input to the virtual reality environment to identify an event;
comparing the event to an event required to complete the task; and
determining whether a user completed the task.

2. The method of claim 1, further comprising:
determining a score for the user based on the comparison of the event to the event required to complete the task.

3. The method of claim 2, further comprising:
displaying the score for the user in a user interface to provide feedback regarding a performance of the user.

4. The method of claim 1, wherein loading the virtual environment associated with the training program comprises:
processing a data model associated with the product to create the virtual reality environment.

5. The method of claim 1, wherein identifying the event based on the user input to the virtual reality environment comprises:
using signals received from virtual reality gloves to identify the event.

6. The method of claim 1, wherein identifying the event based on the user input to the virtual environment comprises:
identifying the event based on signals received from user tracking devices.

7. The method of claim 1, wherein determining whether the user completed the task further comprises:
determining the user partially completed the task; and
displaying an informational message and an instruction on how the user attempt partially completed the task.

8. The method of claim 1, wherein determining whether the user completed the task further comprises:
determining the user failed to complete the task; and
resetting the virtual reality environment for the user to re-attempt the task.

9. The method of claim 1, wherein determining whether the user completed the task further comprises:
determining the user failed to complete the task; and
displaying an error message and an instruction on how the user attempt failed to complete the task.

10. The method of claim 1, wherein determining whether the user completed the task further comprises:
determining the user has completed the task; and
retrieving a subsequent task from the training program.

11. A system for providing virtual reality simulations for training, the system including a processor configured to:
receive a user selection of a training program for a product;
load a virtual reality environment associated with the training program;
retrieve a task of the training program;
process user input to the virtual reality environment to identify an event;
compare the event to an event required to complete the task; and
determine whether a user completed the task.

12. The system of claim 11, wherein the processor is further configured to:
determine a score for the user based on the comparison of the event to the event required to complete the task.

13. The system of claim 12, wherein the processor is further configured to:
display the score for the user in a user interface to provide feedback regarding a performance of the user.

14. The system of claim 11, wherein the processor is further configured to:
process a data model associated with the product to create the virtual reality environment.

15. The system of claim 11, wherein the processor is further configured to:
use signals received from at least one of virtual reality gloves and user tracking devices to identify the event.

16. The system of claim 11, wherein the processor is further configured to:
determine the user partially completed the task; and
display an informational message and an instruction on how the user attempt partially completed the task.

17. The system of claim 11, wherein the processor is further configured to:
determine the user failed to complete the task; and
reset the virtual reality environment for the user to re-attempt the task.

18. The system of claim 11, wherein the processor is further configured to:
determine the user failed to complete the task; and
display an error message and an instruction on how the user attempt failed to complete the task.

19. The system of claim 11, wherein the processor is further configured to:
determine the user has completed the task; and
retrieve a subsequent task from the training program.

20. A non-transitory computer-readable storage medium having stored therein program code of one or more software programs, wherein the program code when executed by at least one processor causes the at least one processor to perform the following steps:
receiving a user selection of a training program for a product;
loading a virtual reality environment associated with the training program;
retrieving a task of the training program;
processing user input to the virtual reality environment to identify an event;
comparing the event to an event required to complete the task; and determining whether a user completed the task.
